(19) United States
(12) Patent Application Publication
(10) Pub. No.: US 2024/0424507 A1
(43) Pub. Date: Dec. 26, 2024

(54) AIR BRUSH

(71) Applicant: Black & Decker Inc., New Britain, CT (US)

(72) Inventors: Karen M. BAUMEISTER, Jarrettsville, MD (US); Andrew M. GAVIN, Reisterstown, MD (US)

(73) Assignee: Black & Decker Inc., New Britain, CT (US)

(21) Appl. No.: 18/822,893

(22) Filed: Sep. 3, 2024

Related U.S. Application Data
(63) Continuation of application No. PCT/US23/15855, filed on Mar. 22, 2023.
(60) Provisional application No. 63/322,410, filed on Mar. 22, 2022.

(51) Int. Cl. B05B 7/00

(52) U.S. Cl. CPC B05B 7/0081

(57) ABSTRACT

An air brush including a removable battery pack, a sprayer body and an air brush tool. The sprayer body includes a housing and a pump housed in the housing. The air brush tool includes an outlet that dispenses an aerosolized fluid. A hose connects the sprayer body and the air brush tool.

### CROSS-REFERENCE TO RELATED APPLICATIONS

This application is a continuation of PCT Application No. PCT/US23/15855 filed Mar. 22, 2023, which claims benefit of U.S. Provisional Patent Application No. 63/322,410 filed Mar. 22, 2022, all of which are incorporated herein by reference in their entirety.

### FIELD OF THE INVENTION

The present invention relates to power tools such as sprayers.

### BACKGROUND

There are various existing battery powered tools. For example, prior art US Patent Application Publication No. 2021/0039243 discloses a variety of small power tools. Prior art CN 213644585 U discloses an air brush. It is desired to provide a powered tool with an improved construction.

### SUMMARY

According to one aspect, there is an exemplary embodiment of a powered tool in the form of an air brush. The air brush, includes a removable battery pack; a sprayer body, the sprayer body including a housing and a pump housed in the housing; an air brush tool, the air brush tool including an outlet configured to dispense an aerosolized fluid; and a hose connecting the sprayer body and the air brush tool.

The removable battery pack may be a power tool battery pack.

The removable battery pack may serve as a weighted base on which the sprayer body is mounted.

The hose may be connected to the sprayer body with a threaded connection.

The hose may be connected to the air brush tool with a threaded connection.

The sprayer body has a first length along a longitudinal axis of the sprayer body.

The removable battery pack may have a second length along a longitudinal axis of the removable battery pack.

The first length may be shorter than the second length.

The removable battery pack may be placed on a flat horizontal surface, a length of the pump in a horizontal direction is greater than a height of the pump in a vertical direction.

The air brush may further include an electrical connection between the removable battery pack to the air brush tool.

The electrical connection may be provided through the hose.

The removable battery pack may be placed on a flat horizontal surface, a height of the pump in a horizontal direction is greater than a height of the pump in a vertical direction.

The sprayer body may further include a circuit board.

The circuit board may be disposed between the pump and the removable battery pack.

The air brush may further include a controller on the circuit board.

The sprayer body may further include an actuator configured to control the pump.

According to another aspect, there is an exemplary embodiment of a powered tool including a removable battery pack; a body, the body including a housing and a pump housed in the housing; a tool portion remote from the body; and a hose connecting the body and the tool portion, the hose providing a fluid connection between the body and the tool portion. The removable battery pack may be configured to serve as a weighted base for the body.

The hose may be connected to the sprayer body with a first threaded connection.

The hose may be connected to the air brush tool with a second threaded connection.

The body may have a first length along a longitudinal axis of the body.

The removable battery pack may have a second length along a longitudinal axis of the removable battery pack.

The first length may be shorter than the second length.

The removable battery pack may be placed on a flat horizontal surface.

A length of the pump in a horizontal direction may be greater than a height of the pump in a vertical direction.

The powered tool may further include an electrical connection between the removable battery pack to the air brush tool.

The body may further include a circuit board.

The circuit board may be disposed between the pump and the removable battery pack.

According to another aspect, there is an exemplary embodiment of a powered tool including a removable battery pack; a body, the body including a housing and a pump housed in the housing; a tool portion remote from the body; and a hose connecting the body and the tool portion, the hose providing a fluid connection between the body and the tool portion. The removable battery pack may be configured to serve as a weighted base for the body. The removable battery pack may be placed on a flat horizontal surface, a length of the pump in a horizontal direction is greater than a height of the pump in a vertical direction. The body may further include a circuit board. The circuit board may be disposed between the pump and the removable battery pack. The body may further include an actuator configured to control the pump.

### BRIEF DESCRIPTION OF THE DRAWINGS

FIG. 1 illustrates a perspective view of an exemplary embodiment of an air

brush according to the present application;

FIG. 2 is a side view of an exemplary embodiment of the air brush;

FIG. 3 is a perspective view of an exemplary embodiment of a sprayer body and battery pack;

FIG. 4 is a side view of an exemplary embodiment of the sprayer body and battery pack;

FIG. 5 is a cut-away side view of an exemplary embodiment of the sprayer body and battery pack; and

FIG. 6 is an explanatory circuit diagram.

### DETAILED DESCRIPTION OF EXEMPLARY EMBODIMENTS

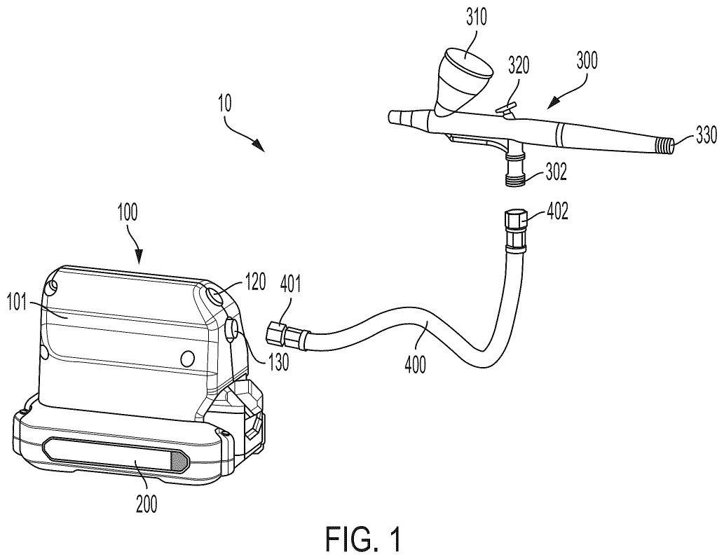

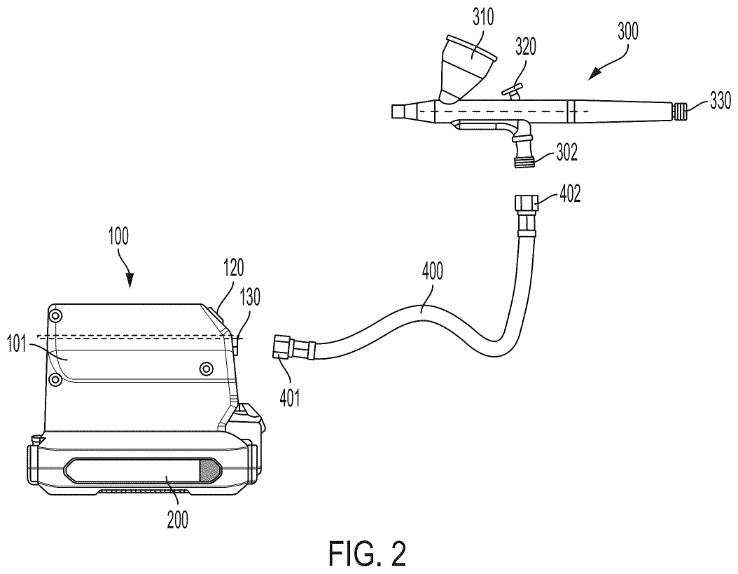

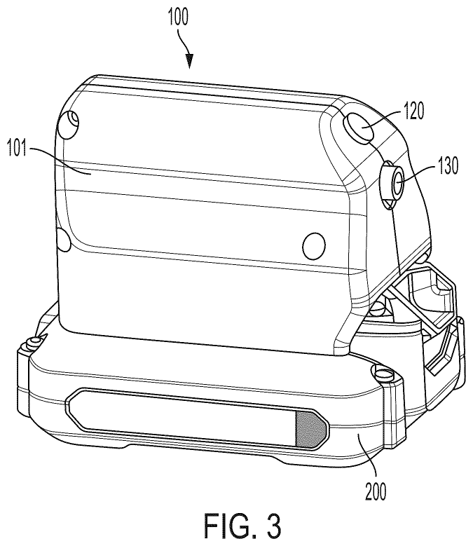

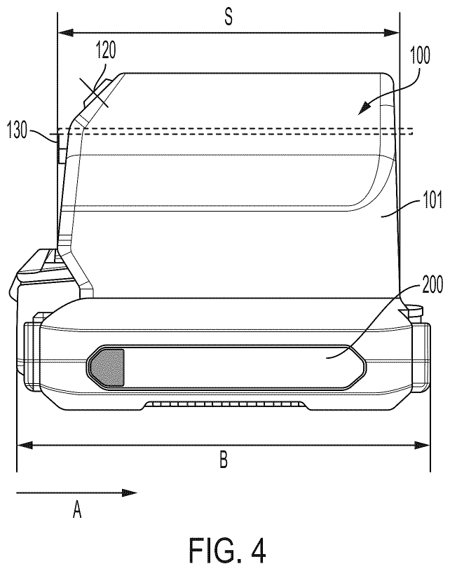

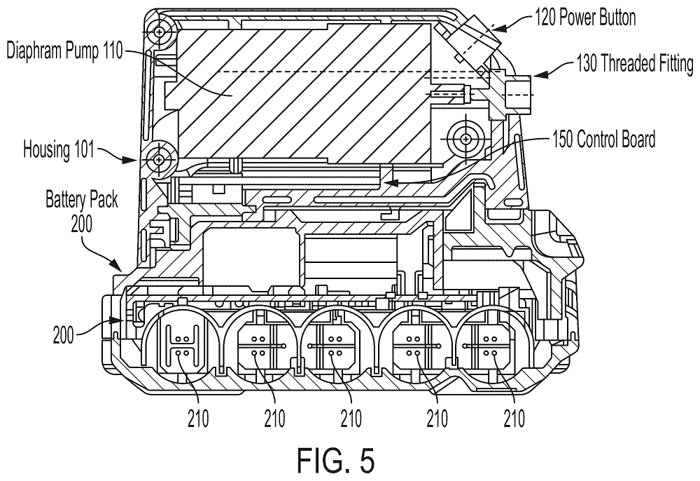

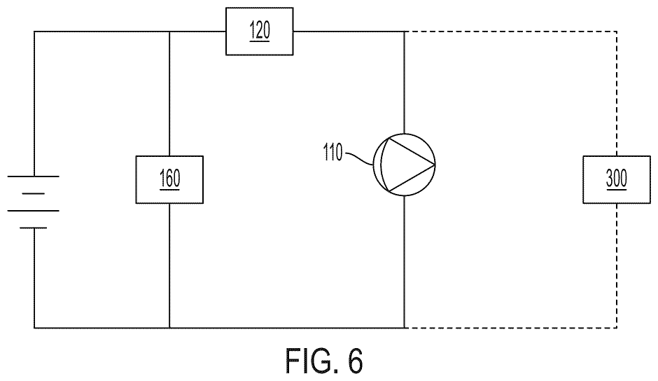

FIGS. 1-6 illustrate an air sprayer or air brush 10 according to a non-limiting exemplary embodiment of the present application. FIGS. 1 and 2 illustrate a side perspective view of the air brush 10. FIGS. 3 and 4 illustrate side views of the sprayer body 100 and battery pack 200. FIG. 5 illustrates a cut-away view of the sprayer body 100 and battery pack 200. FIG. 6 is a schematic diagram.

As shown in FIGS. 1 and 2, the air brush 10 includes a sprayer body 100, a removable power tool battery pack 200, an air brush tool 300, and a hose 400 connecting the sprayer body 100 to the air brush tool 300. As shown in FIG. 5, the sprayer body 100 includes a housing 101. A diaphragm pump 110 is housed in the housing 101. The diaphragm pump 110 is powered by the battery pack 200 and when the pump 110 is activated, such as by actuating power button 120, pumps air through the threaded fitting 130.

The battery pack 200 of the exemplary embodiment is a removable power tool battery pack and may be of the type shown in, for example, U.S. Pat. Nos. 7,598,705; 7,661,486; or U.S. Patent Application Publication No. 2018/0331335. The battery pack 200 may also power tools such as those shown in U.S. Patent Application Publication No. 2021/0039243 U.S. Pat. Nos. 7,598,705; 7,661,486; U.S. Patent Application Publication No. 2018/0331335; and U.S. Patent Application Publication No. 2021/0039243 are hereby incorporated by reference.

As shown in FIGS. 1 and 2, the air brush 10 includes a hose 400. The hose 400 has threaded fittings 401 and 402. The threaded fitting 401 of the hose 400 fits onto the threaded fitting 130 of the sprayer body 100. Threaded fitting 402 fits onto a threaded fitting 302 of the air brush tool 300. The threaded fittings allow the hose 400 to be threaded onto the sprayer body 100 and the air brush tool 300 to provide an air line through the hose from the sprayer body 100 to the air brush tool 300. The pump 110 pushes air through the hose 400 to the air brush tool 300. Liquid is provided to the air brush tool 300 at a cup 310. The liquid may be paint. A user can depress a trigger 320 of the air brush tool 300 and the paint is aerosolized through the output nozzle 330 of the airbrush tool 300 onto an object to be painted.

In operation, a user can attach the battery pack 200 to the sprayer body 100. The user also attaches the hose 400 to the sprayer body 100 and the airbrush tool 300 via the threaded connections 130, 401 and 302, 402. The user also fills the cup 310 with a liquid such as paint. The cup 310 may have a lid which may secure the liquid. To operate, the user presses a power button 120, which activates the pump 110. Once the pump 110 is actuated, the user may depress the trigger 320 and aerosolized paint is dispensed through the output nozzle 330 onto an object such as a workpiece, shirt, art or craft.

As shown, the battery pack 200 of the exemplary embodiment may serve as a weighted base. The battery pack 200 may be placed on a stable surface, such as a flat horizontal surface 500 shown in FIG. 4. The flat horizontal surface 500 may be provided by a table or floor. The mass of the battery pack 200 causes the battery pack 200 and the sprayer body 100 connected to the battery pack 200 to remain in place unless a significant moving force is applied to the battery pack 200 and sprayer body 100. The sprayer tool 300 is remote from the sprayer body 100 and battery pack 200 and can be moved to perform work while the sprayer body 100 and battery pack 200 remain in place.

As shown in FIG. 4, the battery pack 200 is slid in direction “A” in order to connect the battery pack 200 with the sprayer body 100. The sprayer body 100 has a length “S” along the direction A. The battery pack 200 has a length “B” along the direction A. The length S is smaller than the length B such that the sprayer body 100 is contained in a footprint of the battery pack 200 along the direction A. This provides for a compact assembly.

FIG. 5 illustrates a cut-away view of the battery pack 200 and sprayer body 100. As shown, the battery pack 200 includes a plurality of battery cells 210. A control board 150 is contained in the housing 101 of the sprayer body 100. The control board 150 may be a printed circuit board (PCB) on which a controller 160 (FIG. 6), memory and other electronic components may be mounted. The controller 160 may include a microprocessor. The control board 150 and its components may be electrically connected to the battery pack 200, the pump 110 and the power button 120. The controller on the control board 150 may control operation of the pump 110 and may also control discharge of the battery pack 200.

As shown in FIG. 5, the pump 110 is disposed horizontally. In particular, when the battery pack 200 is placed on a flat horizontal surface, a central longitudinal axis of the pump 110 is horizontal. The longitudinal axis of the pump 110 is also parallel to a longitudinal axis of the battery pack 200.

FIG. 6 is a schematic circuit diagram of the battery pack 200 and diaphragm pump 110. In other embodiments, the pump may be a different type of pump. The battery pack 200 is electrically connected to the diaphragm pump 110 to provide power to the pump. A controller 160 is also operatively connected to the diaphragm pump 110 and battery pack 200. The controller 160 may include a microprocessor. Additionally, in some embodiments, the battery pack 200 may be electrically connected to the tool, such as sprayer tool 300. The controller 160 may also be operatively connected to the sprayer tool 300 in some instances. As discussed above, the electrical connection may be made, for example, by a wire attached to or embedded in the hose 400. It may also be a separate electrical connection. In those instances, the sprayer tool 300 or other tool may include an electrical feature in addition to receiving pressurized air from the pump 110. For example, the sprayer tool 300 may have an LED light to provide light to a user. In other instances, the electrical feature could be, for example, a gauge, display, fan, motor, sensor or other feature.

In the exemplary embodiment of the present application, the tool portion is an air brush tool 300. In other embodiments, other tools could be used instead of the air brush tool 300. For example, an inflator, fan or other tool using air supply from an air pump may be used in place of the air brush tool 300.

In some embodiments, the connection between the body 100 and the tool 300 may provide an electrical connection in addition to an air supply. For example, a wire may be included in the hose 400 and electrically connect the battery 200 through the body 100 and to the tool 300. This allows both an air supply and a supply of electricity to be provided to the tool 300. In that instance, the tool 300 may further include a light, such as a light emitting diode (LED). The electricity could also power other or additional electric powered features on the tool 300. The electricity could be operated with the same power button 120 and trigger 320 or there could be additional or separate actuators for the electrical features.

Although described by way of exemplary embodiments, it is understood that the words which have been used herein are words of description, rather than words of limitation. Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims

It is to be understood that the present disclosure contemplates that, to the extent possible, one or more features of any embodiment can be combined or exchanged with one or more features of any other embodiment.

What is claimed is:

1. An air brush, comprising:
a removable battery pack;
a sprayer body, the sprayer body comprising a housing and a pump housed in the housing;
an air brush tool, the air brush tool comprising an outlet configured to dispense an aerosolized fluid; and
a hose connecting the sprayer body and the air brush tool.

2. The air brush of claim 1, wherein the removable battery pack is a power tool battery pack; and
wherein the removable battery pack serves as a weighted base on which the sprayer body is mounted.

3. The air brush of claim 1, wherein the hose is connected to the sprayer body with a threaded connection.

4. The air brush of claim 1, wherein the hose is connected to the air brush tool with a threaded connection.

5. The air brush of claim 1, wherein the sprayer body has a first length along a longitudinal axis of the sprayer body;
wherein the removable battery pack has a second length along a longitudinal axis of the removable battery pack; and
wherein the first length is shorter than the second length.

6. The air brush of claim 1, wherein when the removable battery pack is placed on a flat horizontal surface, a length of the pump in a horizontal direction is greater than a height of the pump in a vertical direction.

7. The air brush of claim 1, further comprising an electrical connection between the removable battery pack and the air brush tool.

8. The air brush of claim 7, wherein the electrical connection is provided through the hose.

9. The air brush of claim 8, wherein when the removable battery pack is placed on a flat horizontal surface, a length of the pump in a horizontal direction is greater than a height of the pump in a vertical direction.

10. The air brush of claim 1, wherein the sprayer body further comprises a circuit board.

11. The air brush of claim 1, wherein the circuit board is disposed between the pump and the removable battery pack.

12. The air brush of claim 11, further comprising a controller on the circuit board.

13. The air brush of claim 1, wherein the sprayer body further comprises an actuator configured to control the pump.

14. A powered tool, comprising:
a removable battery pack;
a body, the body comprising a housing and a pump housed in the housing;
a tool portion remote from the body; and
a hose connecting the body and the tool portion, the hose providing a fluid connection between the body and the tool portion;
wherein the removable battery pack is configured to serve as a weighted base for the body.

15. The powered tool of claim 14, wherein the hose is connected to the sprayer body with a first threaded connection; and
wherein the hose is connected to the air brush tool with a second threaded connection.

16. The powered tool of claim 14, wherein the body has a first length along a longitudinal axis of the body;
wherein the removable battery pack has a second length along a longitudinal axis of the removable battery pack; and
wherein the first length is shorter than the second length.

17. The powered tool of claim 14, wherein when the removable battery pack is placed on a flat horizontal surface, a length of the pump in a horizontal direction is greater than a height of the pump in a vertical direction.

18. The powered tool of claim 14, further comprising an electrical connection between the removable battery pack to the air brush tool.

19. The powered tool of claim 14, wherein the body further comprises a circuit board;
wherein the circuit board is disposed between the pump and the removable battery pack. and

20. A powered tool, comprising:
a removable battery pack;
a body, the body comprising a housing and a pump housed in the housing;
a tool portion remote from the body; and
a hose connecting the body and the tool portion, the hose providing a fluid connection between the body and the tool portion;
wherein the removable battery pack is configured to serve as a weighted base for the body;
wherein when the removable battery pack is placed on a flat horizontal surface, a length of the pump in a horizontal direction is greater than a height of the pump in a vertical direction.
wherein the body further comprises a circuit board;
wherein the circuit board is disposed between the pump and the removable battery pack; and
wherein the body further comprises an actuator configured to control the pump.
